(19) United States
(12) Patent Application Publication
(10) Pub. No.: US 2004/0105538 A1
(43) Pub. Date: Jun. 3, 2004

(54) Telephone with a capacitive environment sensor

(76) Inventor: Klaus Goebel, Munich (DE)

Correspondence Address: BELL, BOYD & LLOYD, LLC, P. O. BOX 1135, CHICAGO, IL, 60690-1135, US

(21) Appl. No.: 10/332,098

(22) PCT Filed: Jun. 27, 2001
(86) PCT No.: PCT/DE01/02375

(30) Foreign Application Priority Data
Jul. 3, 2000 (DE) 100 32 238.7

(51) Int. Cl. H04M 1/00

(52) U.S. Cl. 379/387.01; 379/388.03

(57) ABSTRACT

A telephone is provided which includes a capacitive sensor via which the environment of the telephone's loudspeaker is monitored continuously to determine whether the operator of the telephone is located close to the loudspeaker.

The invention relates to a telephone as claimed in the precharacterizing clause of patent claim 1.

Telephones, in particular cordless telephones, have a loudspeaker which emits audible signals both during normal telephoning, when the loudspeaker of the telephone is held against the ear, and during hands-free use, when the loudspeaker is arranged at a distance from the ear. In the hands-free mode, the volume of the loudspeaker is set to a correspondingly high level.

The high volume in the hands-free operating mode results, however, in the risk of the telephone accidentally being held against the ear, even though the telephone is in the hands-free operating mode, and in the loudspeaker emitting high volume audible signals directly into the ear. This can cause hearing damage.

Telephones are known, in which an optical environment measurement is carried out by means of a reflex light barrier, and the reflected light signal is used to identify whether an operator is located close to the loudspeaker. If this is the case, then the hands-free operating mode is suppressed. However, this has the disadvantage that the telephone easily become dirty, so that the optical measurement becomes unreliable.

The object of the invention is to provide a low-cost and reliable arrangement for monitoring the environment of a telephone.

The object of the invention is achieved by the features of claim 1. One advantage of the invention is that a capacitive sensor is used as the sensor, by means of which the environment of the loudspeaker is monitored continuously to determine whether an operator is located close to the loudspeaker. The use of a capacitive sensor allows a low-cost embodiment and, furthermore, is not sensitive to dirt, and is therefore reliable.

Further preferred embodiments of the invention are characterized in the dependent claims. An improvement in the sensitivity of the sensor is achieved by arranging the sensor in the area of an ear piece on the telephone. The sensor is thus arranged precisely in the area in which an operator's ear is located when telephoning.

A further improvement in the sensitivity of the sensor is achieved by the sensor being arranged at least in the form of a partial ring around the ear piece. In this way, the entire surface area of the sensor is arranged close to the ear piece and, furthermore, it has a relatively large area. The large area allows the sensitivity to be achieved with the capacitive sensor.

Telephones are normally designed in the form of an appliance upper shell and an appliance lower shell. A simple telephone configuration is achieved by fitting the sensor on the rear face of the housing upper shell. The sensor is thus arranged very close to the upper face of the telephone, thus increasing the sensitivity.

A simple configuration is achieved by connecting the sensor to an evaluation circuit via a spring contact. This allows the sensor to be arranged on a component of the telephone which is produced separately and is electrically connected to the evaluation circuit during the assembly by pushing the spring contact onto a corresponding contact point.

A further advantageous embodiment is for the sensor to be arranged on the outside of the telephone.

The invention will be explained in more detail in the following text with reference to the figures, in which:

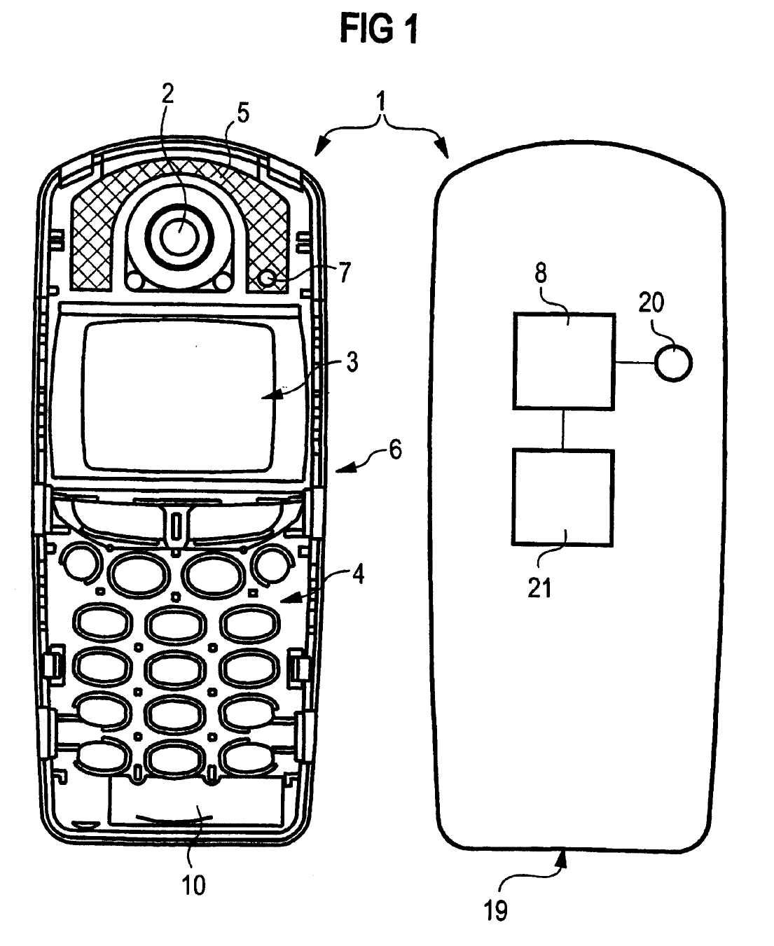

FIG. 1 shows the configuration of a telephone schematically, and

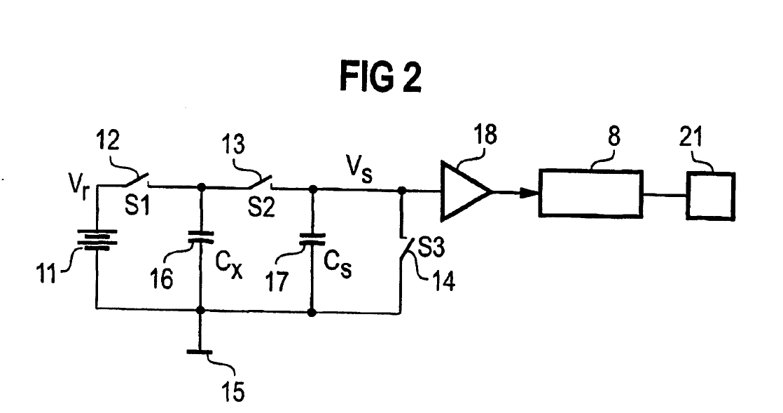

FIG. 2 shows a circuit arrangement for a capacitive sensor.

FIG. 1 shows, schematically, the configuration of a telephone 1 in which the appliance upper shell 6 and the appliance lower shell 19 of the telephone can be seen. The upper area of the telephone 1 has an ear piece 2, which operates as a loudspeaker. A display area 3 on which data can be displayed is provided underneath the ear piece 2. A control panel 4 with keys is provided underneath the display area 3, and allows the telephone 1 to be operated. A microphone 10 is arranged at the lower end, via which audible signals are detected. The audible signals are processed in a computer unit 21 and are changed to digital signals which are transmitted via an antenna.

The ear piece 2 essentially has a circular cross section and is attached directly to the appliance upper shell 6, centrally, in the upper area. A sensor 5 is fitted around the ear piece 2, on the rear face of the appliance upper shell 6. The sensor 5 is in the form of a capacitance and comprises, for example, a large-area electrically conductive layer, which is electrically isolated from the environment by an insulating layer. The conductive layer is, for example, in the form of a metal foil. The shape of the layers is preferably matched to the shape of the ear piece 2 and to the external contour of the housing upper shell 6. The sensor 5 preferably surrounds the ear piece 2 at least in the form of a partial ring, so that the sensor 5 has a relatively large area. In one embodiment, the sensor 5 is essentially U-shaped, with the two limbs of the U-shape being relatively broad in contrast to the tip of the U-shape, and being arranged on both sides in the longitudinal direction of the telephone. The tip of the U-shape is arranged above the ear piece 9.

The area of the sensor 5 should be chosen to be as large as possible in order to achieve a high capacitance. In one preferred embodiment, the sensor 5 is arranged on the upper face of the appliance upper shell 6. In principle, the shape of the sensor 5 may be chosen as desired, and can preferably be matched to the configuration of the telephone. In one preferred embodiment, the sensor 5 is arranged as a transparent film above the withdrawal area 3.

A spring contact 7, which is attached to the sensor 5 and hence to the appliance upper shell 6, is preferably provided for electrical connection of the sensor 5 to an evaluation circuit 8. In the simplest case, the spring contact 7 comprises a spiral, elastic electrical conductor, which is arranged virtually at right angles to the appliance upper shell 6. The spring contact 7 is designed in such a manner that, when the appliance upper shell 6 is joined to the appliance lower shell 19, which has an electrical contact 20, the spring contact 7 is pressed against the electrical contact 20. The electrical contact 20 is connected to the evaluation circuit 8, which is in turn connected to the computation unit 21.

The computer unit 21 monitors the output signal from the evaluation circuit 8. The evaluation circuit 8 uses the capacitive sensor 5 to check whether an operator is located in the vicinity of the ear piece 2. The capacitive sensor has different capacitances, depending on whether or not an operator is located in the area of the ear piece 2. This allows the environment of the ear piece 2 to be monitored using simple technical means.

If the evaluation circuit 8 now finds that the capacitance of the sensor 5 has changed from standard capacitance, than the evaluation circuit 8 emits a signal to the computer unit 21. After receiving a signal from the evaluation circuit 8, the computer unit 21 automatically reduces the volume of the ear piece 2. This reliably avoids damage to the hearing of an operator.

FIG. 2 shows a known circuit arrangement, with which it is possible to monitor an environment with the aid of the capacitive sensor 5, which has a first capacitance 16. The circuit arrangement has a voltage source 11, whose pole is connected to an input of a first switch 12. One output of the first switch 12 is connected to one input of a second switch 13 and to a contact of the capacitive sensor 5. The sensor 5 is in the form of an insulated metal foil. In terms of circuitry the sensor 5 represents a first capacitance 16, with the second contact of the first capacitance 16 being connected to a ground connection 15, which is connected to the negative pole of the voltage source 11.

One output of the second switch 13 is connected to a first contact of an evaluation capacitor 17, to one input of a voltage measurement unit 18 and to one input of a third switch 14. The second contact of the evaluation capacitor 17 and the output of the third switch 14 are likewise connected to the ground connection 15. The input of the third switch 14 is connected to the input of the voltage measurement unit 18. The voltage measurement unit 18 is connected via one output to the evaluation circuit 8.

The circuit arrangement shown in FIG. 2 operates as follows: step 1: the first switch 12 is closed, the second switch 13 is open and the third switch 14 is likewise closed. In this switch position, the first capacitance 16, which has a predetermined capacitance Cx, is charged to a defined reference voltage Vr. The evaluation capacitor 17 is discharged via the third switch 14.

Step 2: the first switch 14 is open, the second switch 13 is open and the third switch 14 is likewise open. In this switch position, the electrical connections for the first capacitor 16 are open for a short time. The first capacitor 16 then carries the charge Q=Cx×Vr.

Step 3: the first switch 12 is open, the second switch 13 is closed, and the third switch 14 is open. In this switch position, the charge on the first capacitor 16 flows to the evaluation capacitor 17, which has a predetermined capacitance Cs which is very much greater than the capacitance Cx of the first capacitor 16. The voltage on the evaluation capacitor 17 is measured by the voltage measurement unit 18 after a predetermined waiting time. The voltage measurement unit 18 has a very high-impedance input, so that the measured voltage value Vs is calculated using the following formula:

Vs=Vr×(Cx/Cs).

Steps 1 to 3 are then carried out cyclically. A calibration is carried out using the first voltage values produced in this way. The capacitance values Cx can then be calculated continuously from the voltage measured values Vs. It is thus possible to select whether a dielectric or conductive object is approaching the area of the ear piece. If an operator is located in the vicinity of the sensor 5, then the value Cx of the first capacitance 16 increases.

The evaluation circuit 8 uses the measured voltage value Vs for a given voltage Vr and a known capacitance of the evaluation capacitor 17 Cs to calculate the value Cx of the first capacitance 16 of the sensor 5. If the calculated capacitance is not the same as the predetermined capacitance, then an operator is identified as being in the vicinity of the ear piece. The evaluation circuit 8 passes an output signal to the computer unit 21 if there is any difference between the calculated value of the first capacitance and the predetermined value. The computer unit 21 then switches the telephone from the hands-free operating mode to the normal telephoning operating mode, in which the volume of the ear piece 2 is low.

One major idea of the invention is to provide a reliable protection mechanism against unacceptably high sound levels which occur in a telephone when the telephone is in the hands-free operating mode but the telephone is nevertheless held directly against the ear.

1. A telephone having
an appliance upper shell (6),
loudspeaker for emitting an audible signal,
a device for adjustable the volume of the loudspeaker,
a sensor (5) for monitoring whether an operator is located in an area close to the loudspeader, and
having an evaluation circuit (8), which is associated with the sensor (5)and by means of which the volume of the loudspeaker can be adjusted as a function of the detected proximity of the operator,
with the sensor (5) being in the form of a capacitive sensor (5), characterized
in that the sensor (5) is fitted on the rear face of the appliance upper shell (6)
in that the sensor (5) has a spring contact (7), and
in that the sensor (5) is electrically connected to the evaluation circuit (8) via the spring contract (7).

2. The telephone as claimed in claim 1, characterized in that an ear piece (2) is provided as the loudspeaker, and in that the sensor is arranged in the area of the ear piece (2).

3. The telephone as claimed in claim 2, characterized in that the sensor (5) is arranged at least in the form of a partial ring around the ear piece (2).

4. The telephone as claimed in claim 1 or 3, characterized in that the sensor (5) is arranged on the surface of the telephone.
